(19) United States
(12) Patent Application Publication
(10) Pub. No.: US 2012/0226751 A1
(43) Pub. Date: Sep. 6, 2012

(54) Geographically Based Location, Alert, and Retrieval System for Lost Animals

(76) Inventor: Melissa Schwaderer, New York, NY (US)

(21) Appl. No.: 13/409,596

(22) Filed: Mar. 1, 2012

Related U.S. Application Data
(60) Provisional application No. 61/447,876, filed on Mar. 1, 2011.

(51) Int. Cl. G06F 15/16

(52) U.S. Cl. 709/204

(57) ABSTRACT

A system and method for reuniting lost animals with their owners. More particularly, the invention relates to an optionally pre-registered, geographically based, location and retrieval system for lost animals, and a method for reuniting lost animals with their owners.

### INCORPORATION BY REFERENCE

All documents cited or referenced in this application along with any descriptions, specifications, or product sheets mentioned in this application are incorporated by reference and may be employed in the practice of the invention.

The citation or identification of any document in this application is not an admission that the document is available as prior art to the present invention.

### FIELD OF THE INVENTION

The present invention relates to a system and method for reuniting lost animals with their owners. More particularly, the invention relates to a geographically based, location, alert and retrieval system for lost animals, and a method for reuniting lost animals with their owners.

### BACKGROUND OF THE INVENTION

Currently, little support exists for animal owners to help locate their lost animal. Similarly, little support exists for individuals interested in assisting owners of lost animals in the search-and-retrieval process of a lost animal. When an animal goes missing, time becomes a critical factor. After a short amount of time, many lost animals suffer from car accidents, encounters with wild animals, dehydration, or illness. Once an animal owner has lost an animal, most owners are left with few options, many of which are expensive or time consuming. Too frequently, an animal owner's ability to find a lost animal is limited by the size of their social network and their ability to travel distances to locate their lost animal.

U.S. Pat. No. 5,036,610 refers to a system of identifying lost animals and finding its owner through the use of a pet tag or collar and a unique identification number. This patent teaches that the identification number is pre-registered by the animal owner with a clearing house. When a lost animal has been found, the finder can call the clearing house and retrieve information to reunite the animal with the owner. This system does not have the capability to generate or distribute a lost-animal alert, i.e., a notification indicating that an animal has gone missing, for the lost animal. In addition, this system does permit interested individuals the ability to opt into receiving lost-animal alerts in order to participate in the search for a lost animal.

U.S. Pat. No. 6,792,465 refers to a system of registering lost-and-found animals through the Internet. Owners of lost animals may search the database to see if someone has found their animal. This system lacks the ability to alert individuals interested in participating in the search-and-retrieval process of a lost animal, lacks the ability to notify individuals within a particular geographic area of a lost animal at the time of the animal's disappearance, and does not permit interested individuals the ability to opt into receiving alert notifications to participate in a search for a lost animal.

U.S. Pat. No. 6,401,095 refers to a system that uses unique identification numbers and computer systems to algorithmically determine the distance a lost dog could travel based on pre-registered information such as the animal's breed and other descriptive elements. The system then generates notifications of the lost animal via e-mail and phone to individuals and business within a particular geographic area. This system does not target individuals within a particular geographic area and does not discriminate when sending alert notifications. In addition, this system does not permit interested individuals the ability to opt into receiving alert notifications to participate in the search for a lost animal.

Current animal search-and-retrieval systems do not permit individuals interested in searching for lost animals to sign up for lost-animal alerts. Because individuals are not permitted to opt into or sign up to receive lost-animal alerts, the current systems rely on indiscriminate public information. In addition, current systems do not take advantage of technologies such as social networks, mobile applications, and GPS systems to target interested individuals within a pre-selected and particular geographic area in order to increase the likelihood that an individual will locate an owner's lost animal.

Therefore, a need still exists in the art to develop a system and method that utilizes technologies such as social networks, mobile applications, and GPS systems while allowing interested individuals within a particular geographic area to participate in the search for a lost animal.

### SUMMARY OF THE INVENTION

Accordingly, it is an object of the invention to provide a system and method for reuniting lost animals with their owners by allowing interested individuals within a particular geographic area to participate in the search for a lost animal. Individuals interested in reuniting lost animals with their owners may participate in the search-and-retrieval process regardless of whether or not they own an animal. Individuals interested in participating in the search-and-retrieval process for a lost animal may sign up to receive geographically based lost-animal alerts.

The present invention may be implemented with a host server or computer that can be accessed by animal owners and individuals interested in receiving lost-animal alerts through a communications network. Animal owners are able to register information about their animal through a communications network, which may include but is not limited to websites and toll-free numbers. During the registration process, the animal owner provides information about themselves and their animal. In addition, the animal owner can purchase a unique identification number for each animal they possess, which is preferably placed on a tag that attaches to an animal's restraint or collar (the identification number can manifest itself in many forms, e.g. a number etched or written onto the surface of the tag; having the identification number transformed into a QR code placed on the tag, etc.). Registration in this manner allows animal owners to register in-depth information about their animal and can speed up the recovery time in the event their animal goes missing. Animal owners registering their animal may also sign up to receive lost-animal alerts, which will notify them if other animals within their geographic area have been reported as missing.

Another aspect of the invention allows individuals interested in assisting owners of lost animals to participate in the search-and-retrieval process by allowing that individual to register their contact information and sign up to receive lost-animal alerts. The lost-animal alerts will notify interested individuals if animals within their geographic area have been reported as missing.

Anyone who loses an animal, registered or not, may generate a lost-animal alert. When a lost-animal alert is generated by an individual through a mode of communication, such the Internet, mobile application, or phone, a lost-animal alert is released through various modes of communication to individuals within a particular geographic area who have expressed interest in receiving lost-animal alerts. The system and method utilizes modes of communication that include but are not limited to e-mail, phone, sms, mms, mobile applications, websites, fax, and social networks to distribute the alert to those individuals who have indicated that they wish to receive lost-animal alerts within a particular geographic location or who are within a geographic location pre-determined by their GPS location.

Another aspect of the invention allows the system and method to notify individuals or animal owners that an animal has been found within a particular geographic location.

These and other embodiments are disclosed or are apparent from and encompassed by, the following Detailed Description.

### BRIEF DESCRIPTION OF THE DRAWINGS

The following detailed description is not intended to limit the invention solely to the specific embodiments described, but may best be understood in conjunction with the accompanying drawings, in which:

FIG. 1 is a flowchart providing an overview of the geographically based registration, alert, and retrieval system for lost animals, in accordance with a preferred embodiment of the present invention.

FIG. 2 is a flowchart illustrating the registration process in accordance with a preferred embodiment of the present invention.

FIG. 3 is a flowchart illustrating the alert process in accordance with a preferred embodiment of the present invention.

FIG. 4 is a flowchart illustrating the retrieval process in accordance with a preferred embodiment of the present invention.

FIG. 5 shows an animal wearing a collar in accordance with a preferred embodiment of the present invention.

FIG. 6 shows an enlarged view of an animal tag in accordance with a preferred embodiment of the present invention.

### DETAILED DESCRIPTION OF THE INVENTION

The following briefly describes the embodiments of the invention in order to provide a basic understanding of some aspects of the invention. The detailed description is not intended as an extensive overview. It is not intended to narrow the scope of the instant invention.

General Operation

The present invention is directed towards a registration, alert, and retrieval system for lost animals. Animal owners can register information about themselves and their animal so that in the event their animal goes missing, individuals who locate a lost animal can reunite the lost animal with its owner. In addition, individuals interested in helping to retrieve a lost animal may choose to receive lost-animal alerts in order to participate in the search for a missing animal. The disclosed system and method not only permits interested individuals the ability to participate in the search for a lost animal, but it also allows animal owners to communicate with individuals interested in helping to retrieve a lost animal so that the interested individual may assist in the location-and-retrieval process.

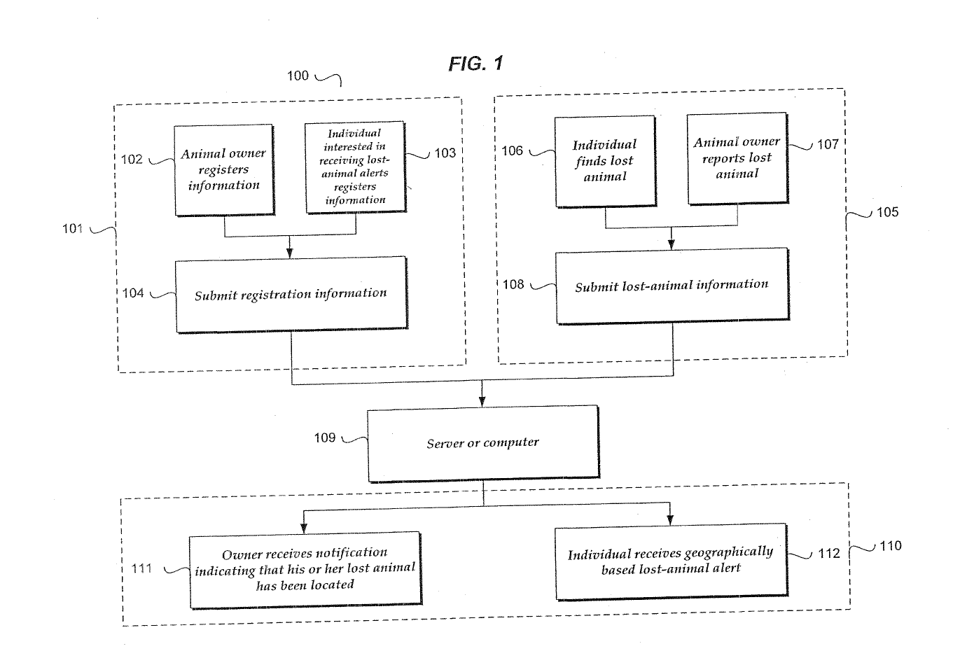

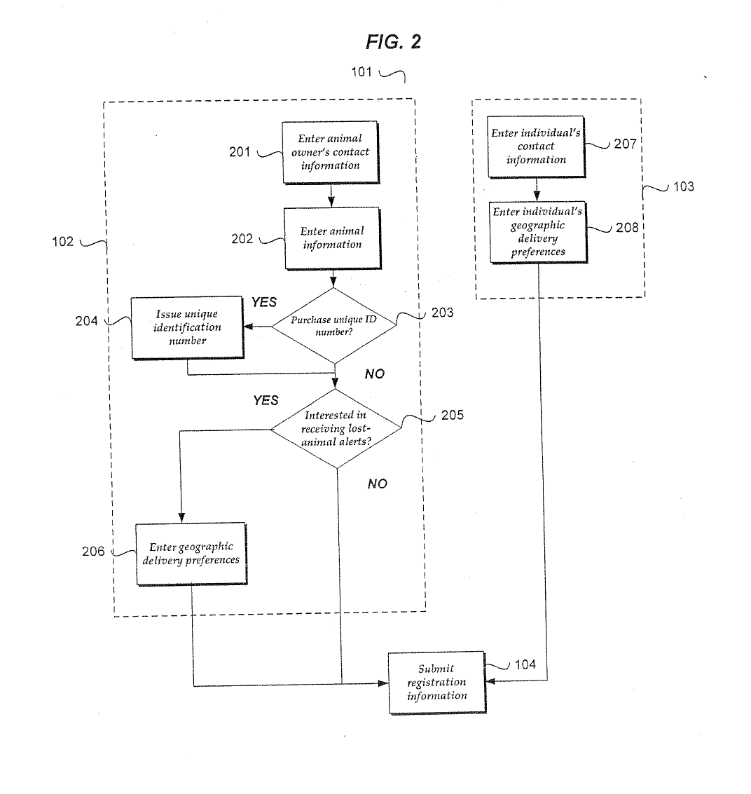

FIG. 1 shows the geographically based registration, alert, and retrieval system for lost animals 100, in accordance with one embodiment of the invention. In this embodiment, registration process 101 allows animal owners or individuals interested in receiving animal alerts to register 102 and submit 104 information about themselves and/or their animal with a server or computer 109. Registration in this manner increases the likelihood that a lost animal will be reunited with its owner in the event the owner's animal goes missing. Registration processes 102 and 104 are described in more detail below in conjunction with FIG. 2.

In another embodiment of registration process 101, individuals interested in receiving lost-animal alerts register 103 and submit 104 information about themselves with a server or computer 109. Registration in this manner also increases the likelihood that a lost animal will be reunited with its owner in the event an owner's animal goes missing because individuals within a particular geographical area will receive a lost-animal alert in the event an animal goes missing within a pre-determined geographical area. Registration processes 103 and 104 are described in more detail below in conjunction with FIG. 2.

The alert process 105 of the preferred embodiment allows individuals who find lost animals to access the server or computer 109 and generate lost-animal alerts so that an animal owner or individual interested in receiving lost-animal alerts may be notified of a lost animal. Specifically, in one embodiment of the alert process 105, an individual who finds a registered lost animal 106 submits information about that animal 108 to a server or computer 109. Lost-animal-alert processes 105 increases the likelihood that a lost animal will be reunited with their owner because once an individual submits information about a registered or unregistered lost animal, the server or computer 109 will notify animal owners or individuals interested in receiving lost-animal alerts of the lost animal.

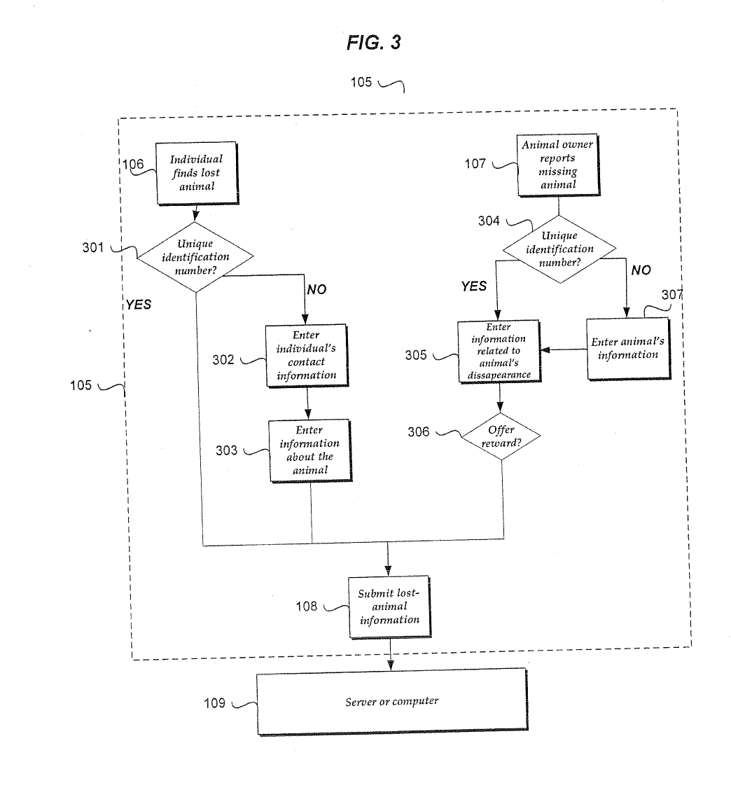

In another preferred embodiment of alert process 105, animal owners who have lost their animal 107 submit lost-animal information to a server or computer 109. The server or computer 109 generates a lost-animal alert in order to notify other animal owners and individuals interested in receiving lost-animal alerts that they have lost their animal. Alert process 105 is described in more detail below in conjunction with FIG. 3.

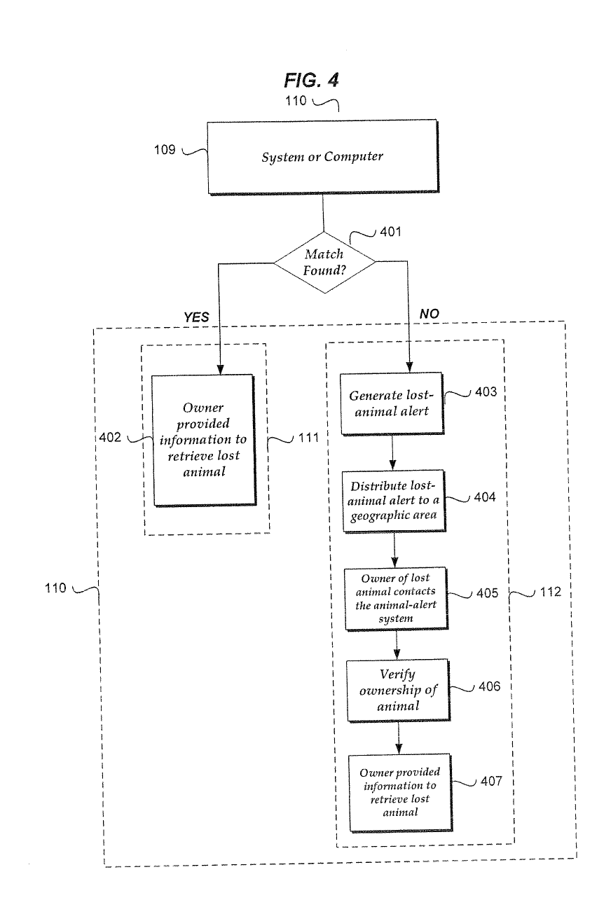

In the retrieval process 110 of the preferred embodiment, the server or computer 109 generates a lost-animal alert and distributes the lost-animal alert to animal owners 111 and individuals interested in receiving lost-animal alerts 112 within a certain geographic area. The retrieval process 110 increases the chances that an owner of a lost animal will be reunited with its lost animal. Retrieval process 110 is described in more detail below in conjunction with FIG. 4.

Registration Process

FIG. 2 depicts a preferred embodiment of registration process 101. An animal owner interested in registering their animal with the optionally pre-registered, geographically based, location and retrieval system for lost animals begins registration process 101 by connecting with the server or computer 109 and entering personal contact information 201. Personal contact information can include, but is not limited to, the individual's name, address, e-mail address, and telephone number. In addition, the animal owner may indicate how he or she prefers to be notified in the event their animal has been located. Once the animal owner has entered his or her personal contact information and has indicated his or her delivery preferences, the server or computer 109 prompts the animal owner to enter information about their animal 202. The information about the animal can include, but is not limited to, the type of animal (e.g., dog or cat), the animal's name, breed, gender, color, age, a photo of the animal, or any other physical characteristics.

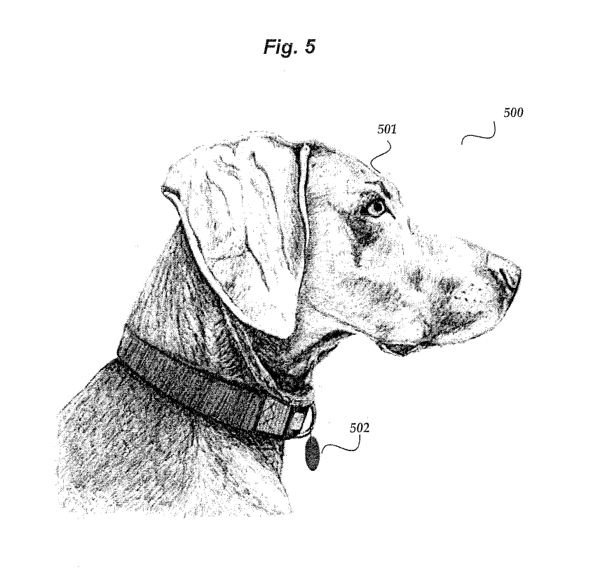

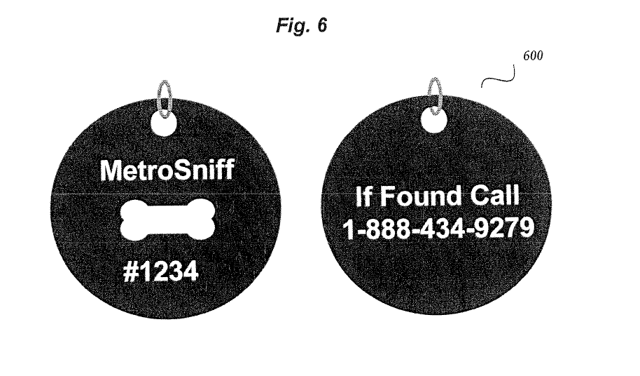

The animal owner may also purchase a unique identification number for his or her animal 203. If the animal owner chooses to purchase a unique identification number, the server or computer 109 will issue a unique identification number and send an animal tag with that unique identification number to the animal owner 204. FIG. 5 illustrates an animal 501 wearing an animal tag 502, in accordance with a preferred embodiment of invention 500. FIG. 6 shows an enlarged view of the animal tag in accordance with a preferred embodiment of the present invention 600.

If the animal owner chooses not to purchase a unique identification number, the server or computer 109 will not assign the animal a unique identification number.

The server or computer 109 will ask the animal owner whether he or she would be interested in receiving lost-animal alerts for other animals within his or her geographical area 205. If the animal owner indicates that he or she would like to receive lost-animal alerts for other animals, the server or computer will prompt the animal owner to enter information about his or her geographic-delivery preferences 206. In one embodiment, the server or computer requests that the animal owner enter zip codes. In the event an animal goes missing within that zip code, the animal owner will receive a lost-animal alert. The animal owner will then submit their registration information 104 which will be stored by the server or computer 109.

In the preferred embodiment of registration process 101, an individual interested in receiving lost-animal alerts 103 connects with the server or computer 109 and enters personal contact information 207. Personal contact information can include, but is not limited to, the individual's name, address, e-mail address, and telephone number, and message-delivery preferences. The server or computer 109 will prompt the interested individual to enter information about his or her geographic-delivery preferences 208. In one embodiment, the server or computer requests that the interested individual enter zip codes. In the event an animal goes missing within that zip code, the interested individual will receive a lost-animal alert.

The interested individual will then submit their registration information 104 which will be stored by the server or computer 109.

Alert Process

FIG. 3 depicts a preferred embodiment of alert process 105. Alert process 105 provides individuals who find lost animals and animal owners who have lost an animal the ability to access the server or computer 109 in order to generate a lost-animal alert.

In a preferred embodiment of the alert process 105, individuals who have found a lost animal 106 access the server or computer 109 in order to generate a lost-animal alert. Individuals who find a lost animal indicate whether the animal they have found has a unique identification number 301. As illustrated in FIG. 6, the unique identification number may be located on the animal tag 602. In addition, the animal tag contains information instructing the individual to contact the animal-alert system. The instructions found on the animal tag could direct the individual to contact the animal-alert system through a variety of modes of communication, including but not limited to e-mail, phone, or Internet website. If the animal has a unique identification number, the individual submits that information 108 and the system or computer 109 and stores that information in its database.

If the animal does not have a unique identification number, the system or computer 109 asks the individual to enter personal contact information 302 and information about the animal 303. The individual submits his or her personal contact information along with the information about the animal 108 and the server or computer 109 stores that information in its database.

In another preferred embodiment of the alert process 105, animal owners who have lost their animal 107 access the server or computer 109 in order to generate a lost-animal alert. Animal owners who wish to generate a lost-animal alert indicate whether the animal they have lost has a pre-registered unique identification number 304.

If the animal has a unique identification number, the individual submits that information and submits information related to the animal's disappearance 305. Information related to the animal's disappearance includes, but is not limited to, information about where the animal was last seen or where the animal was lost. The animal owner may also choose to offer a reward for finding his or her lost animal 306. The animal owner submits the unique identification number, information related animal's disappearance, and reward information 108 and the system or computer 109 stores it in its database.

If the animal does not have a unique identification number, the animal owner submits information about the animal 307. The animal owner also submits information related to the animal's disappearance 305 and indicates whether he or she wishes to offer a reward for finding their lost animal 306. The animal owner submits this information 108 and the system or computer 109 stores it in its database.

Retrieval Process

FIG. 4 depicts a preferred embodiment of the retrieval process 110. Retrieval process 110 notifies animal owners that their animal has been found 111 or generates lost-animal alerts 112.

In a preferred embodiment of the retrieval process 110, the system or computer 109 compares information submitted during the registration process 104 with information submitted during the alert process 108. The server or computer 109 determines whether to issue a lost-animal alert or whether to contact the owner of a lost animal. The information stored in the server or computer 109 includes but is not limited to the animal owner's or individual's contact information, animal information submitted by animal owners, and geographic-location and alert-delivery preferences for individuals interested in receiving lost-animal alerts.

If the information submitted during the alert process 105 and the registration process 101 matches or closely matches 401, the system or computer 109 contacts the owner of the lost animal and provides the animal owner with information to retrieve his or her lost animal 402. If the information submitted during the registration process 104 does not match or does not closely match the information submitted during the alert process 108, the system or computer 109 generates a lost-animal alert 403. The system or computer 109 then distributes the lost-animal alert to individuals within a particular geographic area 404. The system or computer 109 utilizes modes of communication which include but are not limited to e-mail, phone, sms, mms, mobile applications, websites, fax, as well as social networks to distribute the alert to those individuals who have indicated that they wish to receive lost-animal alerts within that geographic location or who are within a geographic location pre-determined by their GPS location.

When an animal owner who receives a lost-animal alert identifies that animal as his or her lost animal, the animal owner contacts the animal-alert system to coordinate retrieval of their lost animal 405. The animal owner may utilize various modes of communication to contact the animal-alert system. These modes of communication include but are not limited to calling a toll-free number, submitting information via the Internet (e.g., a social network or a web application), or e-mail. The system or computer 109 confirms that the individual claiming ownership of the lost animal is, in fact, the actual owner, by requesting certain information 406. Information requested by the system or computer 109 to verify ownership of an animal includes but is not limited to photos of the lost animal, descriptive information about the animal, and information about microchips. Once the system or computer 109 has verified the ownership of the animal 406, it provides the animal owner with information so that they may retrieve their animal 407.

One of ordinary skill in the art can easily envision that the present method of retrieving lost animals and system therefore, can be adapted to expand its usefulness to retrieve lost children, persons suffering from a disability or the effects of old age for parents, spouses, other loved ones (e.g. relatives, friends) or concerned individuals (health care workers; day care workers, teachers, etc.).

Having described in detail various embodiments of the present invention, it is to be understood that the invention defined by the paragraphs above and by the drawings is not to be limited to particular details set forth above as many apparent variations of invention are possible without departing from the spirit or scope of the present invention.

What is claimed is:

1. A method for retrieving lost animals comprising:
(a) a registration process wherein an animal owner and/or other individuals besides the animal owner who are interested in receiving alerts about lost animals are registered by submitting information about themselves (and their animal if the animal owner) into a server or computer; wherein
(i) the submitting of information optionally comprises submitting contact information and geographic delivery preferences; and
(ii) the registration process optionally comprises the issuance of a unique identification number after the submission of information;
(b) an alert process wherein
(i) the lost animal owner submits information into the server or computer about the lost animal; and subsequent to the generation of an alert;
(ii) other individuals besides the animal owner who are interested in receiving alerts about lost animals or non-registered finders of lost animals submit information about a found animal into the server or computer; and
(c) a retrieval process wherein the information submitted during step (ii) of the alert process is compared to the information submitted during the registration process, wherein,
(i) if the information submitted during step (ii) of the alert process substantially matches the information submitted during the registration process thereby indicating the lost animal has been located, the server or computer generates and sends a message to the animal owner; or
(ii) if the information submitted by the lost animal owner during the alert process does not substantially match the information submitted by other individuals besides the animal owner who are interested in receiving alerts about lost animals or non-registered finders of lost animals during the registration process thereby indicating the lost animal has not been located, or if information has not yet been submitted by other individuals besides the animal owner, the server or computer generates and sends a lost animal alert;
wherein retrieval process steps (i) and (ii) are repeated until the lost animal has been found.

2. The method of claim 1, wherein in step (i) of the registration process submitting contact information and geographic delivery preferences is part of the registration process.

3. The method of claim 2, wherein in step (ii) of the registration process, a unique identification number after the submission of information is issued.

4. The method of claim 3, wherein in step (i) of the alert process, the animal owner submits information related to the animals disappearance and/or the offer of a reward to the finder of the lost animal.

5. The method of claim 3, wherein upon receipt of the message in the retrieval process by the animal owner, the animal owner coordinates retrieval of the lost animal by communicating with the server or computer.

6. The method of claim 5, wherein the means of communication with server or computer is selected from the group consisting of telephone call, wireless communications, and submission of information via the Internet.

7. The method of claim 5, wherein the server or computer compares the communication of the animal owner with the information from the registration process to verify ownership of the animal and whereby the server or computer transforms the information into a retrieval message to the animal owner if ownership is confirmed or a non-retrieval message to the animal owner is ownership is not confirmed.

8. A system for the retrieval of lost animals comprising a server or computer which has been configured to conduct the process steps of:
(a) a registration process wherein an animal owner and/or other individuals besides the animal owner who are interested in receiving alerts about lost animals are registered by submitting information about themselves (and their animal if the animal owner) into a server or computer; wherein
(i) the submitting of information optionally comprises submitting contact information and geographic delivery preferences; and
(ii) the registration process optionally comprises the issuance of a unique identification number after the submission of information;
(b) an alert process wherein
(i) the lost animal owner submits information into the server or computer about the lost animal; and subsequent to the generation of an alert;
(ii) other individuals besides the animal owner who are interested in receiving alerts about lost animals or non-registered finders of lost animals submit information about a found animal into the server or computer; and
(c) a retrieval process wherein the information submitted during step (ii) of the alert process is compared to the information submitted during the registration process, wherein,
(i) if the information submitted during step (ii) of the alert process substantially matches the information submitted during the registration process thereby indicating the lost animal has been located, the server or computer generates and sends a message to the animal owner; or
(ii) if the information submitted by the lost animal owner during the alert process does not substantially match the information submitted by other individuals besides the animal owner who are interested in receiving alerts about lost animals or non-registered finders of lost animals during the registration process thereby indicating the lost animal has not been located, or if information has not yet been submitted by other individuals besides the animal owner, the server or computer generates and sends a lost animal alert; wherein retrieval process steps (i) and (ii) are repeated until the lost animal has been found.

9. The system of claim 8, wherein in step (i) of the registration process submitting contact information and geographic delivery preferences is part of the registration process.

10. The system of claim 9, wherein in step (ii) of the registration process, a unique identification number after the submission of information is issued.

11. The system of claim 10, wherein in step (i) of the alert process, the animal owner submits information related to the animals disappearance and/or the offer of a reward to the finder of the lost animal.

12. The system of claim 10, wherein upon receipt of the message in the retrieval process by the animal owner, the animal owner coordinates retrieval of the lost animal by communicating with the server or computer.

13. The system of claim 12, wherein the means of communication with server or computer is selected from the group consisting of telephone call, wireless communications, and submission of information via the Internet.

14. The system of claim 12, wherein the server or computer compares the communication of the animal owner with the information from the registration process to verify ownership of the animal and whereby the server or computer transforms the information into a retrieval message to the animal owner if ownership is confirmed or a non-retrieval message to the animal owner is ownership is not confirmed.
